(19) United States
(12) Patent Application Publication
(10) Pub. No.: US 2012/0182276 A1
(43) Pub. Date: Jul. 19, 2012

(54) AUTOMATIC ADJUSTMENT OF DISPLAY SYSTEMS BASED ON LIGHT AT VIEWER POSITION

(75) Inventor: Tommy Wing Chau Kee, Richmond (CA)

(73) Assignee: Broadcom Corporation, Irvine, CA (US)

(21) Appl. No.: 13/092,676

(22) Filed: Apr. 22, 2011

Related U.S. Application Data
(60) Provisional application No. 61/434,268, filed on Jan. 19, 2011.

(51) Int. Cl. G06F 3/038; G09G 5/10

(52) U.S. Cl. 345/207; 345/690

(57) ABSTRACT

Methods, systems, and apparatuses are described for automatic adjustment of display systems based on ambient light intensity. Ambient light intensity of a viewing environment is determined from a location of a display system or from a location separate from the display system. Ambient light information may be collected using light sensor(s) or image sensor(s) of a camera or other imaging capturing device. When a viewer is present, ambient light intensity may be determined from a perspective of the viewer. The determined light intensity information is used to determine a white balance level. A characteristic of the display system is adjusted based on the determined white balance level.

### CROSS REFERENCE TO RELATED APPLICATION

This application claims the benefit of U.S. Provisional Application No. 61/434,268, filed on Jan. 19, 2011, which is incorporated by reference herein in its entirety.

### BACKGROUND OF THE INVENTION

1. Field of the Invention

The present invention relates to display systems, and more particularly, to techniques for the adjustment of display systems based on environmental characteristics.

2. Background Art

Electronic display systems, from televisions (TVs) to portable systems that are capable of displaying images, are widely used in many lighting conditions. Display systems require proper luminance or brightness values for accurate image reproduction. Usually, display characteristics such as brightness or contrast may be manually or automatically adjusted in the display systems. For example, on a liquid crystal display (LCD), a brightness control, also called black level, adjusts how dark black sections of a picture appear. Similarly, a contrast control, also called picture or white level, adjusts the level of intensity and detail of bright or white parts of an image. Note that some display systems have controls labeled as brightness and contrast, but the controls may have different functions than like-named controls of other systems. For example, brightness and contrast controls of an LCD may not adjust the identical display characteristics as brightness and contrast controls of a cathode-ray tube (CRT) monitor.

Misadjusted brightness and contrast levels result in poor quality image reproduction. For instance, a display system with brightness set too high can render a two-dimensional, washed-out image. A display system with brightness set too low can cause distinctions and details in dark areas to disappear. High contrast can make it difficult to perceive picture details and cause eyestrain in low light setting. Furthermore, a display system with a high contrast setting may consume more power. Low contrast, on the other hand, can result in dull images with little visible details in the white areas. Therefore, it is important to determine an ambient light intensity of a viewing environment and adjust display characteristics according to the ambient lighting condition.

Typically, a display system contains a light sensor mounted on the device to measure ambient light level. The light sensor measures characteristics of light received by the display system from the environment. The measured light information may be used to adjust certain characteristics of the display system, such as brightness and/or contrast level of a display of the device, to improve a viewing experience of viewers. However, because the light sensor receives light from the environment directed towards the display system, the characteristics of the display system are adjusted based on the light received from the environment, rather than the light received at a viewer position.

While display characteristics such as brightness and contrast may be manually set by viewers, it can be disruptive and cumbersome for a viewer to manually determine the appropriate menus and settings to adjust the display to the correct level to produce the best picture quality. This may be exacerbated if a lighting condition in a viewing area frequently changes.

### BRIEF SUMMARY OF THE INVENTION

Methods, systems, and apparatuses are described for automatically adjusting a display system based on light at a viewer position substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example of a viewing environment in which a display system has a light sensor.

FIG. 2 shows an example of a viewing environment in which a display system implements a camera according to an embodiment.

FIG. 3 shows a flowchart for automatically adjusting a display system based on light in a viewing area, according to example embodiments.

FIG. 4 shows a display system depicted with its modules, according to example embodiments.

FIG. 5 shows a plurality of processes that may be incorporated into the flowchart of FIG. 3, according to example embodiments.

FIG. 6 shows a camera, according to example embodiments.

FIG. 7 shows a process that may be incorporated into the flowchart of FIG. 3, according to example embodiments.

FIG. 8 shows a process that may be incorporated into the flowchart of FIG. 3, according to example embodiments.

FIG. 9 shows a display system having a separate sensor system, according to an example embodiment.

FIG. 10 shows a flowchart for collecting light data, according to an example embodiment.

FIG. 11 shows a sensor system, according to example embodiments.

FIG. 12 shows a display system depicted with its modules, according to an example embodiment.

FIG. 13 shows a process that may be incorporated into the flowchart of FIG. 10, according to an example embodiment.

FIG. 14 shows a process that may be incorporated into the flowchart of FIG. 10, according to an example embodiment.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### II. Example Embodiments for Automatic Adjustment of Display Systems Based on Ambient Light Intensity

In embodiments, characteristics of light received at viewers in a viewing environment are used to adjust a display system to improve the quality of images displayed to the viewers. For instance, in an embodiment, one or more light characteristics may be sensed, and used to determine ambient light intensity. Using the determined light intensity, a white balance level of the display system may be automatically adjusted. In another embodiment, a backlight level is automatically adjusted based on the determined light intensity. In further embodiments, additional and/or alternative display system characteristics may be adjusted based on characteristics of the light received at the viewers. Automatic adjustment of display systems can have various advantages, including improving the viewer experience, and reducing power consumption, extending the battery life of many portable devices.

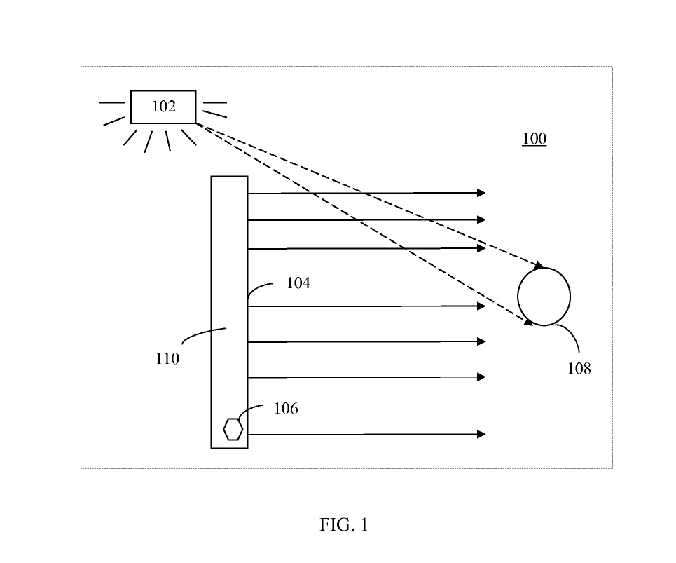

For example, FIG. 1 shows a display system 110 in a viewing area or environment 100. Display system 110 includes a display screen 104, on which images may be rendered. For example, display system 110 may be a flat panel TV, and display screen 104 may be a TV screen configured to render programming content. Furthermore, display system 110 includes a light sensor 106 at display screen 104 for detecting ambient light from a perspective of display system 110. As such, in environment 100, light detection is localized to the immediate area around display system 110.

Viewing environment 100 may further include a light source 102. Light source 102 may be anything that emits light, and it may be natural (e.g., the sun) or artificial (e.g., a lamp). Note that more than one light source 102 may be present in environment 100, which may the same type of light source or different types of light sources. Light source 102 may be located anywhere in viewing environment 100. In FIG. 1, light source 102 is located behind display system 110 such that it is outside a field of view of light sensor 106. In such a configuration, light source 102 may diminish the ability of a viewer 108 to see image(s) rendered on display screen 104, because light source 102 emits light into the eyes of viewer 108. However, light emitted from light source 102 may not be detected by light sensor 106 because it is not within the field of view of light sensor 106. Thus, light sensor 106 is inadequate in detecting light from a perspective of viewer 108. Light received by light sensor 106 may be analyzed and used to adjust the display of images to viewer 108 by display system 110. Because light sensor 106 does not sense the light received by viewer 108 (e.g., light from light source 102), the display of images by display system 110 is not adjusted based on the viewpoint of viewer 108.

In embodiments, lighting information at a location of viewer is collected to determine environmental light characteristics, such as ambient light intensity, from a perspective of the viewer. In this manner, a display system can be adjusted to display images to the viewer in an improved manner relative to the configuration of FIG. 1. For example, the display system may be adjusted to display images in a manner that is more tailored to the viewpoint of the viewer rather than being calibrated based on a perspective of the display system.

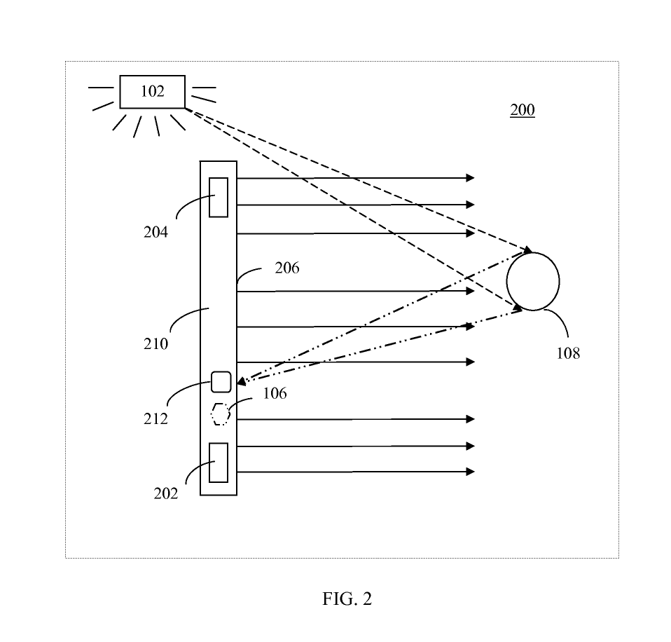

For instance, FIG. 2 shows a display system 210 in a viewing environment 200, according to an example embodiment. Viewing environment 200 may be a room or any other place (indoor or outdoor) where display system 210 is located and used. A lighting condition of viewing environment 200 may be static or dynamic, ranging from little to frequent changes in lighting that result in corresponding adjustment of the brightness and/or contrast levels of display system 210. As shown in FIG. 2, display system 210 emits images (e.g., displays video, etc.) from a display surface 206 of display system 210 to a viewer 108 (and optionally further viewers) in viewing environment 200.

Display system 210 may be any type of device that has a display, stationary or mobile. Some stationary examples of display system 210 include a cathode ray tube (CRT) display, a liquid crystal display (LCD), a light emitting diode (LED) display, a plasma display, a display of a desktop computer, a television, or other stationary display type. Mobile or portable displays include displays that are designed to withstand movement, and in some cases may be small and/or light enough to be carried by a user (e.g., handheld, etc.). Some example mobile versions of display system 210 include a display system in a vehicle, a portable gaming system, a handheld music player, a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), a portable navigation device, etc.

As shown in FIG. 2, display system 210 includes light sensor 106 (optionally), at least one camera 212, and internal light sources 202 and 204. Camera 212 enables light characteristics to be determined from a perspective of viewer 108, including determining light characteristics at or around an eye level of viewer 108. Display system 210 may optionally include light sensor 106 for detecting an ambient light level from a perspective of display system 210. While not shown in FIG. 2, multiple light sensors 106 and/or cameras 212 may be present in display system 210. In addition, display system 210 may include no internal light source (e.g., neither of light sources 202 and 204) one internal light source, or more than two internal light sources.

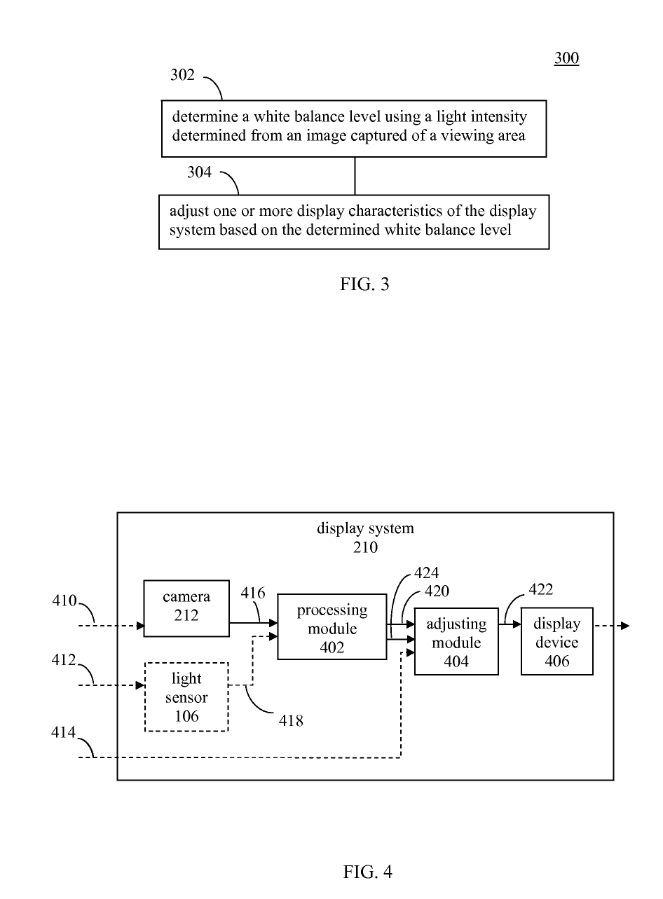

As shown in FIG. 2, light source 102 may be located behind a plane of display system 210 relative to viewer 108. Even though light source 102 is located behind display system 210, its effects on viewer 108 may be determined because camera 212 is configured to capture an image of viewer 108. For instance, light characteristics (e.g., light intensity) as perceived by viewer 108 may be determined from the captured image. Such light characteristics may include characteristics of the light of light source 102 shining on viewer 108. For instance, an image captured of viewer 108 by camera 212 may indicate light of light source 102 shining on viewer 108. The captured image may indicate that viewer 108 is brightly illuminated by light of light source 102, or may indicate that little light is actually being received by viewer 108 (e.g., viewer 108 may appear dimly lit). As such, a captured image of a viewer may be used to determine light characteristics from the perspective of the viewer. Example embodiments for capturing image(s) and determining light characteristics are described with respect to FIG. 3.

FIG. 3 shows a flowchart 300 for automatically adjusting a display, according to example embodiments. Flowchart 300 may be implemented by display system 210 of FIG. 2, in an embodiment. Flowchart 300 is described as follows with respect to FIG. 2 and FIG. 4. FIG. 4 shows a block diagram of an example of display system 210, according to an embodiment. As shown in FIG. 4, display system 210 includes light sensor 106, camera 212, a processing module 402, an adjusting module 404, and a display device 406. Further structural and operational embodiments will be apparent to persons skilled in the relevant art(s) based on the discussion regarding flowchart 300.

Flowchart 300 begins with step 302. In step 302, a white balance level is determined using a light intensity determined from at least an image captured of a viewing area. For example, referring to FIG. 2, camera 212 may receive light 410 from the direction of viewer 108 to capture an image of viewer 108, which is output from camera 212 as a captured image 416. Camera 212 may be any suitable type of imaging device that is capable of capturing images, including a digital camera, an image sensor such as a charged coupled device (CCDs), a CMOS (complementary metal-oxide-semiconductor) sensor, or other type of imaging device. Captured image 416 may include image data in any suitable form, including red-green-blue pixel data (e.g., arranged in a Bayer pattern image), or image data in other form, as would be known to persons skilled in the relevant art(s).

Light sensor 106 is optionally present. Light sensor 106 is configured to detect light at one or more light wavelengths/frequencies. When present, light sensor 106 may receive light 412, which may correspond to ambient light received at display screen 104 of display system 210, and may output sensed light indication 418. Light sensor 106 may include one or more of any type of light sensing device that is not capable of imaging (capturing a complete image), including a photosensor, a photodetector, a photodiode, etc.

Internal light sources 202 and 204 are configured to provide backlighting for display device 406 by transmitting light from the back of display device 406 toward display surface 206 to produce a visible image. For example, on a display system 210 that includes an LCD, internal light sources 202 and 204 are configured to produce light that is transmitted across the back of the LCD to a liquid crystal layer. An electrical voltage may be used to control the orientation of the liquid crystal, which affects the amount of light of light sources 202 and 204 that is passed through each red, green, and blue sub-pixel of a pixel. The combined intensity of light from each pixel creates a visible image on display surface 206. Internal light sources 202 and 204 may include one or more of any type of light emitting devices, such as incandescent light bulbs, light-emitting diodes (LEDs), electroluminescent panels (ELP), cold cathode fluorescent lamps (CCFL), hot cathode fluorescent lamps (HCFL), etc. The type of internal light source chosen for display system 210 depends on factors such as color gamut, power consumption, heat generation, size, and cost.

Processing module 402 receives and processes captured image 416. For instance, processing module 402 may determine one or more light characteristics at the location of viewer 108 by processing captured image 416. In one embodiment, a white balance level may be determined by processing module 402 based on captured image 416. Processing module 402 may determine such light characteristics, including white balance level, using techniques known to persons skilled in the relevant art(s). Processing module 402 may be implemented in hardware, software, firmware, or any combination thereof. For instance, processing module 402 may be implemented as computer program code configured to be executed in one or more processors, including a generic processor and/or an image processor. Alternatively, processing module 402 may be implemented as hardware logic/electrical circuitry.

As shown FIG. 4, processing module 402 may optionally receive sensed light indication 418 from light sensor 106. Sensed light indication 418 is a signal (e.g., a voltage, a digital value, etc.) that is indicative of an amount of light received by light sensor 106 (e.g., is indicative of brightness or light intensity) of one or more light wavelengths/frequencies. In an embodiment, processing module 402 is configured to receive captured image 416 from camera 212 and any other cameras that may be present in display system 210 as well as sensed light indication 418 from light sensor 106 and other sensors that may be present in display system 210. Processing module 402 generates an effective measured light intensity value from the received captured image 416 and sensed light indication 418. The effective measured light intensity value may be a weighted average of light received in captured image 416 and sensed light indication 418, or a value generated based on captured image 416 and sensed light indication 418 according to another linear or non-linear mathematical scheme (e.g., logarithmic). The effective measured light intensity value may be used to determine an appropriate color balance (e.g., a white balance level). Color balance may be used by processing module 402 to correct differences in ambient illumination conditions. This aids in neutral colors (e.g., gray, achromatic, white, etc.) in a scene being rendered as neutral by a display screen of a display device 406 (e.g., an LCD display, a plasma display, etc.) of display system 210. Additionally, processing module 402 may be configured to use sensed light indication 418 to determine one or more additional color correction schemes for adjusting the display of display device 210.

With reference to step 302 of FIG. 3, processing module 402 may be configured to determine a white balance level by determining one or more light characteristics from captured image 416 to remove unrealistic color casts, such that neutral colors are rendered correctly by display device 406, as shown in FIG. 2. Processing module 402 may also be configured to determine the white balance level based on captured image 402 by using other techniques that will be known to persons skilled in the relevant art(s), such as by using a lookup table, for example.

As shown in FIG. 4, processing module 402 outputs an adjustment parameter 420 indicating the determined white balance level and an adjustment parameter 424 indicating the effective measured light intensity value. Adjustment parameters 420 and 424 may be generated continuously or periodically to accommodate changes in light levels in the environment. For instance, if display system 210 includes a portable display (e.g., a cellular phone, etc.), adjustment parameters 420 and 424 may be generated more frequently to accommodate the portable display that may frequently be in motion, leading to frequent changes in lighting condition of viewing environment 200. If display system 210 does not include a portable display, adjustment parameters 420 and 424 may be generated less frequently.

Adjustment parameter 420 contains information that may be used to adjust one or more display characteristics. For instance, display characteristics, such as brightness, may be adjusted based on the adjustment parameter 420 by incrementing or decrementing red, green, and/or blue pixel values of an image such that black picture content appears as true black on the display screen of display device 406. For instance, in an embodiment, if the determined white balance level indicates that viewing environment 200 is brightly lit from the perspective of viewer 108, adjustment parameter 420 is generated to contain a positive value (or a negative or other corresponding value) corresponding to the determined white balance level. As a result, the brightness setting of display device 406 may be adjusted by incrementing red, green, and/or blue pixel values of the image rendered by display device 406. In another embodiment, if the determined white balance indicates that viewing environment 200 is dimly lit from the perspective of viewer 108, adjustment parameter 420 is generated to contain a negative value (or a positive or other corresponding value) corresponding to the determined white balance level. As a result, the brightness setting of display device 406 may be adjusted by decrementing red, green, and/or blue pixel values of the image rendered by display device 406.

Furthermore, adjustment parameter 420 may include a scale factor. Display characteristics, such as contrast, may be adjusted by applying the scale factor to the red, green, and blue signals of a video signal such that white picture content is rendered with appropriate detail on the display screen. For example, in one embodiment, if the determined white balance level indicates that the viewing environment 200 is brightly lit from the perspective of viewer 108, adjustment parameter 420 is generated to indicate a relatively lower scale factor (e.g., less than 1). As a result, the contrast setting of display device 406 may be adjusted by decreasing red, green, and/or blue pixel values of the image rendered by display device 406. In another embodiment, if the determined white balance indicates that viewing environment 200 is dimly lit from the perspective of viewer 108, adjustment parameter 420 is generated to contain a relatively larger scale factor. As a result, the contrast setting of display device 406 may be adjusted by increasing red, green, and/or blue pixel values of the image rendered by display device 406.

Adjustment parameter 424 also contains information that may be used to adjust one or more display characteristics. For example, in an embodiment, a backlight level may be adjusted. If the effective measured light intensity value indicates viewing environment 200 is dimly lit, adjustment parameter 424 is generated to have a value that causes the backlight level to be decreased to save power and to create an optimum viewing experience. However, if the effective measured light intensity value indicates that viewing environment 200 is brightly lit, adjustment parameter 424 is generated to have a value that causes the backlight level be increased such that the content on display surface 206 is adequately visible to viewer 108.

Referring to FIG. 3, in step 304, one or more display characteristics of the display system are adjusted based on the determined white balance level. For example, referring to FIG. 4, adjusting module 404 is configured to receive adjustment parameter 420 from processing module 402 as well as a video signal 414. Video signal 414 contains video content to be displayed by display screen 204 of display system 210. For instance, video signal 414 may be received by display system 210 in a wireless or wired manner. For instance, video signal 414 may be a land-based video broadcast transmission or a satellite broadcast transmission, may be received from a video source device such as a digital video disc (DVD) player, from a set top box (e.g., from cable), from a stereo receiver, from a hard drive, from a memory device, etc. Video signal 414 may include video data transported in any form, including composite video, an S-video, component video signal, an HDMI (High-Definition Multimedia Interface) signal, etc.

Adjusting module 404 may use adjustment parameter 420 to modify video signal 414 to modify display characteristics of display system 210. Examples of display characteristics include contrast, brightness, color balance, etc. For instance, to modify video signal 414, adjusting module 404 may add or subtract an offset or apply a gain to video signal 414 based on adjustment parameter 420 to generate a modified video signal 422. Pixel data in video signal 422 may be modified to bright colors, darken colors, apply contrast to colors, etc., As shown in FIG. 4, adjusting module 404 generates modified video signal 422, which is the adjusted form of video signal 414. Modified video signal 422 is received by display device 406, and is rendered for display by display screen 204.

Furthermore, one or more display characteristics of the display system are adjusted based on the effective measured light intensity value. For example, in one embodiment, adjusting module 404 is further configured to adjust the backlight level of display system 210 based on adjustment parameter 424 received from processing module 402. Adjusting module 404 may adjust display system 210 more frequently when display system 210 includes a portable display, and adjustment parameter 424 therefore changes value more frequently. In an embodiment, the backlight level may be adjusted by applying pulse-width modulation to a supply current, which causes the internal light sources 202 and 204 to turn on and off The frequency of the pulse-width modulation determines how fast the internal light sources 202 and 204 switch on and off. A low frequency (e.g., dim or low backlight level) may result in flicker that can cause discomfort and eye-strain, and a high frequency (e.g., full backlight level) may have a negative impact on image quality and excessive power consumption. Adjustment parameter 424 may correspond to an appropriate frequency given the effective measured light intensity value. Alternatively, adjustment parameter 424 may correspond to a change in frequency that is needed to provide the optimum viewing experience given the effective measured light intensity value. Adjusting module 404 is configured to automatically adjust the backlight level of display system 210 based on adjustment parameter 424 such that the content shown on display device 406 is adequately visible to viewer 108. For example, in the case where display system 210 includes an LCD, the display surface 206 may appear dimmer or brighter, depending on the frequency of the pulse-width modulation used by adjusting module 402. In the case where display system 210 is a display system in a vehicle, adjusting module 404 may automatically adjust dashboard lights such that they appear dimmer or brighter according to adjustment parameter 424.

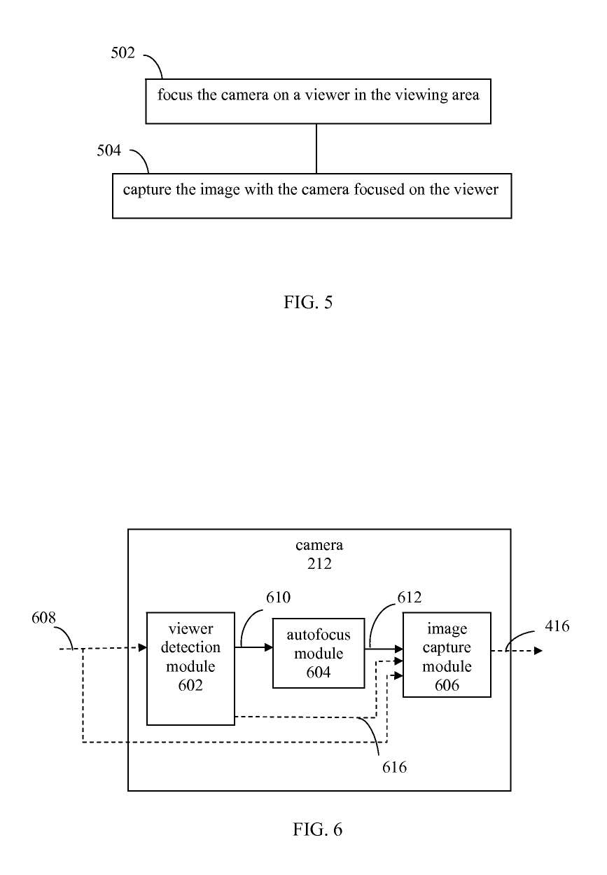

Camera 212 may capture images used to determine display characteristics in a variety of ways according to embodiments. For instance, FIG. 5 shows example processes that may be incorporated into flowchart 300 of FIG. 3, according to embodiments. The processes of FIG. 5 may be performed by camera 212 shown in FIG. 6, for example. FIG. 6 shows a block diagram of camera 212, according to an example embodiment. As shown in FIG. 6, camera includes a viewer detection module 602, an autofocus module 604, and an image capture module 606. FIG. 5 is described as follows with reference to FIG. 6, for purposes of illustration.

As shown in FIG. 5, in step 502, the camera focuses on a viewer in the viewing area. For instance, as described above with respect to FIG. 2, camera 212 is configured to focus on viewer 108 in viewing environment 200. Camera 212 may focus to capture still and/or moving images and may include any of a variety of types of stationary, moveable (e.g., rotatable), and adjustable lenses, such as normal, wide-angle, long-focus, close-up, zoom, special-purpose, etc. In addition, while not shown in FIG. 2, camera 212 may be mounted on or within the housing of display system 210 or it may be detachable from display system 210.

Viewer detection module 602, autofocus module 604, and image capture module 606 enable camera 212 to rotate, scan, detect, track, and focus on a person, object, or thing. Viewer detection module 602, autofocus module 604, and image capture module 606 may be implemented in hardware, software, firmware, or any combination thereof For instance, viewer detection module 602 may be implemented as a computer program code configured to be executed in one or more processors, including a generic processor and/or an image processor. Alternatively, viewer detection module 602 may be implemented as hardware logic/electrical circuitry. The modules shown in FIG. 6 are described as follows.

If a viewer is present, viewer detection module 602 enables camera 212 to detect that viewer (e.g., viewer 108) in environment 200. For example, viewer detection module 602 may include active motion sensors that inject energy (e.g., light, microwaves, or sound) into viewing environment 200 in order to detect a change in the energy indicative of a presence of a viewer. Viewer detection module 602 may also include passive sensors that detect infrared energy. For instance, the passive sensors may be sensitive to the temperature of a human body. In another embodiment, viewer detection module 602 may direct image capture module 606 to capture a first image of the viewing environment in front of camera 212. Viewer detection module 602 may perform a facial recognition technique on the first image to detect one or more viewers in the viewing environment. Viewer detection module 602 may select one of the viewers (e.g., a closest viewer (e.g., viewer with largest face), a furthest viewer, a viewer at a middle distance, etc.), and may instruct autofocus module 604 using a trigger signal 610 to focus in the direction of the selected viewer according to step 502.

Referring to FIG. 5, in step 504, the image is captured with at least one camera focused on the viewer. For instance, as shown in FIG. 6, autofocus module 604 enables camera 212 to automatically focus on the viewer (e.g., viewer 108 of FIG. 2) before the image is captured. In an embodiment, autofocus module 604 may include an active system that emits energy (e.g., sound waves) into viewing environment 200 and receives an echo to determine the distance between camera 212 and viewer 108. Autofocus module 604 may alternatively include an active system that uses infrared signals to detect the distance to viewer 108. A variety of techniques may be used to determine the distance to viewer 108, such as triangulation, time, or amount of infrared light reflected from viewer 108. Autofocus module 604 may further or alternatively include a passive system that determines the distance to viewer 108 by conducting a computer analysis of an image of viewing environment 200. The passive system analyzes the captured image and moves a lens (not depicted in FIG. 6) backward and forward to determine the best focus. Once viewer 108 is in focus, autofocus module 604 generates focus parameters 612, which are transmitted to image capture module 606.

Image capture module 606 is configured to receive light 608 from the direction of viewer 108 and focus parameters 612, both of which are used to capture an image of viewing environment 200 with viewer 108 in focus. Captured image 416, which is generated by image capture module 606, is transmitted to processing module 402 for processing. Captured image 416 may be generated by exposing a light sensor, such as a CCD or CMOS sensor to light 608. A CCD or CMOS may include an array of thousands or greater numbers of pixels. When a CCD or CMOS sensor is exposed to light 608, an electrical charge is built up at each pixel. The electrical charge may be measured and converted to a digital signal. A filter, such as a Bayer filter may be placed over the CCD or CMOS sensor to record colors. The output of the Bayer filter is an array of color pixels (e.g., red, green, and blue) of different intensity, corresponding to the electrical charge measured at each pixel. The color array may be interpolated to determine true colors, which form captured image 416. Captured image 416 may be uncompressed (e.g., a TIFF format), or compressed (e.g., a JPEG format).

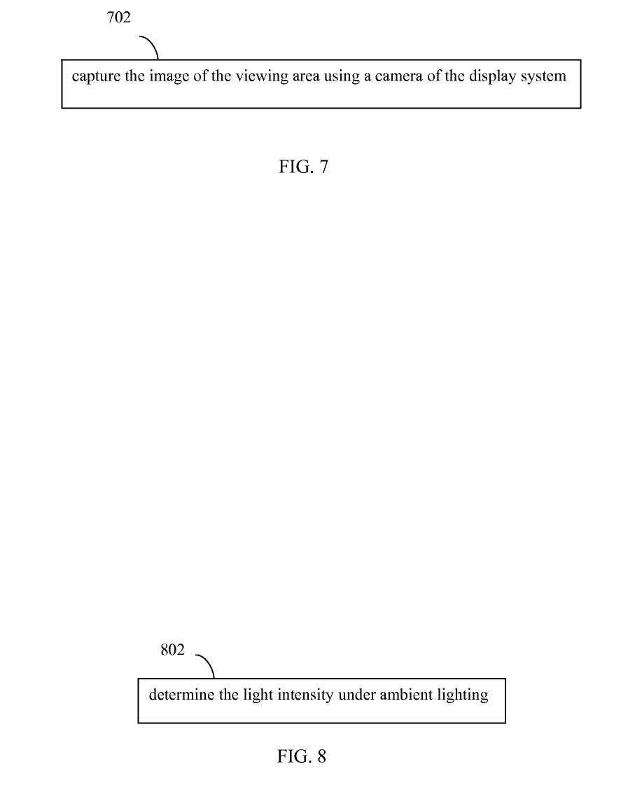

When no viewer is present in viewing environment 200, a step 702 shown in FIG. 7 may be performed with reference to camera 212 shown in FIG. 6. In step 702, the image of the viewing area is captured using a camera of the display system. When a viewer is not present or detected by viewer detection module 602, camera 212 may be configured to capture an image of viewing environment 200 while focusing on an object (e.g., a wall or a ceiling) or on nothing at all. If a viewer is not detected, after a time threshold (e.g., 10 seconds), viewer detection module 602 may generate a timeout signal 616 to image capture module 606. Upon receipt of timeout signal 616, image capture module 606 is configured to automatically capture an image of viewing environment 200 without focusing on a viewer.

FIG. 8 shows a step 802 where light intensity is determined under ambient lighting, according to an example embodiment. For example, step 802 may be performed by processing module 402 shown in FIG. 4. In such an embodiment, processing module 402 is configured to receive one or both of captured image 416 from camera 212 or sensed light indication 412 from light sensor 106 to determine light intensity under ambient lighting. Ambient light is light surrounding an environment or subject (e.g., viewing environment 200, viewer 108). Ambient light may be a combination of light reflections from various surfaces.

### III. Example Embodiments for Collecting Data for Determining Light Intensity

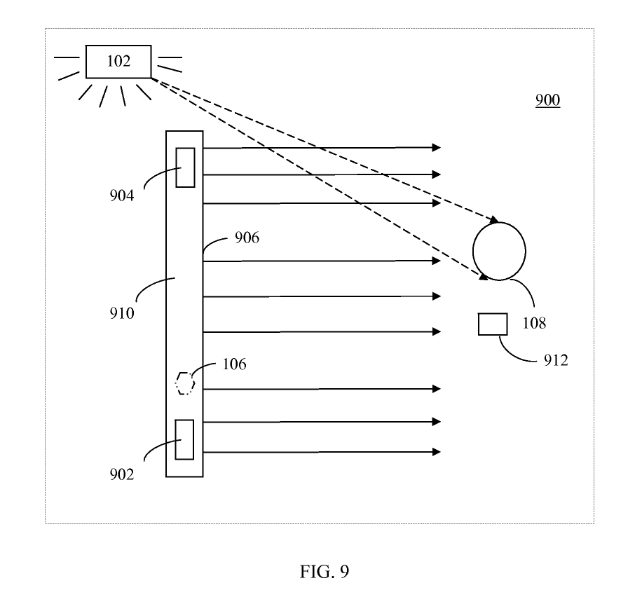

In embodiments, characteristics of ambient light at the location of viewers in a viewing environment are used to adjust a display system to improve the quality of images displayed to the viewers. Example embodiments are described in this section for collecting data to determine light intensity with a sensor system that is separate from the display system. For instance, FIG. 9 shows a view of a viewing environment 900, according to an example embodiment. Viewing environment 900 is generally similar to viewing environment 200 of FIG. 2. As shown in FIG. 9, viewing environment 900 includes a display system 910 and a sensor system 912. Display system 910 includes internal light sources 902 and 904, and one optional light sensor 106. As shown in FIG. 9, display system 910 emits images from a display screen 906 of display system 910 to a viewer 108 (and optionally further viewers) in viewing environment 900. FIG. 9 is different from FIG. 2 in that sensor system 912 is separate from display system 910.

Similarly to display system 210 of FIG. 2, display system 910 may be any type of device that has a display, stationary or mobile. Some stationary examples of display system 910 include a cathode ray tube (CRT) display, a liquid crystal display (LCD), a light emitting diode (LED) display, a plasma display, a display of a desktop computer, a television, or other stationary display type. As described above, mobile or portable displays include displays that are designed to withstand movement or light enough to be carried by a user. Some example mobile versions of display system 910 include a display system in a vehicle, a portable gaming system, a handheld music player, a mobile computing device (e.g., a personal digital assistant (PDA), a laptop computer, a notebook computer, a tablet computer (e.g., an Apple iPad™), a netbook, etc.), a mobile phone (e.g., a cell phone, a smart phone, etc.), a portable navigation device, etc. Sensor system 912 may be a standalone, separate device, or may be included within another device or system, such as a handheld remote control device (for controlling a television or other display system), a web camera, a gaming system component, etc.

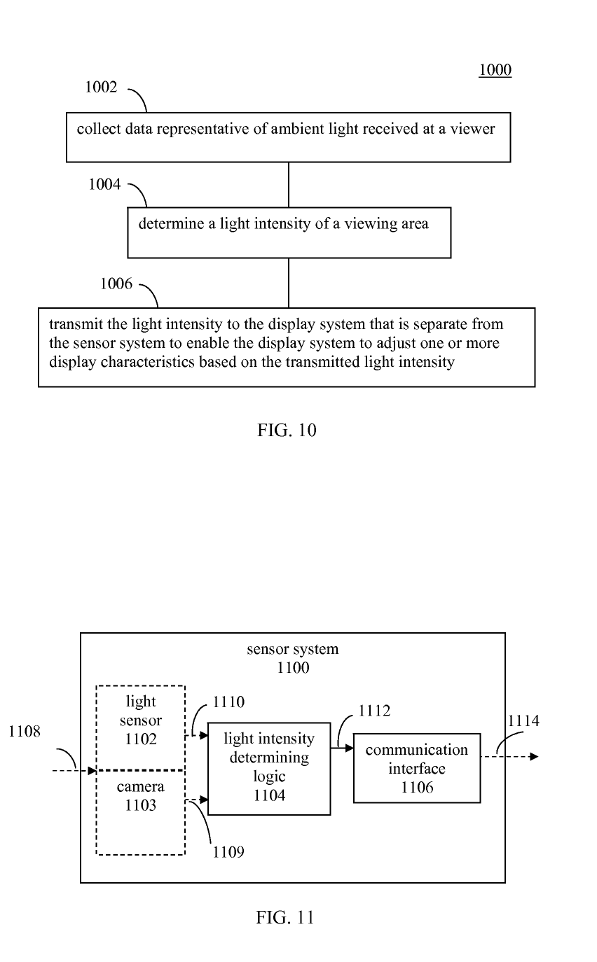

Similarly to the configurations of FIGS. 1 and 2, in FIG. 9, light source 102 may be located behind a plane of display system 910 relative to viewer 108. As such, light source 102 is outside the field of view of light sensor 106, and the light that it emits cannot be accounted for in calibrating the display characteristics of display system 910. Sensor system 912 is configured to collect light characteristics at a location of viewer 108, and to transmit information regarding the collected light characteristics to display system 910, thereby enabling display system 910 to be accordingly calibrated. Example embodiments for collecting data to determine light intensity at a location of viewers are described with respect to FIG. 10.

FIG. 10 shows a flowchart 1000 for collecting data to determine light intensity at a location of a viewer, according to example embodiments. Flowchart 1000 may be implemented by sensor system 912 shown in FIG. 9, in an embodiment. However, the method of flowchart 1000 is not limited to that embodiment. For instance, FIG. 11 shows a block diagram of a sensor system 1100, according to an example embodiment. Sensor system 1100 is an example of sensor system 912 of FIG. 9. As shown in FIG. 11, sensor system 1100 includes at least one of a camera 1102 or a light sensor 1103, a light intensity determining logic 1104, and a communication interface 1106. Further structural and operational embodiments will be apparent to persons skilled in the relevant art(s) based on the discussion regarding flowchart 1000. Flowchart 1000 is described as follows with respect to FIG. 11 for purposes of illustration.

Flowchart 1000 begins with step 1002. In step 1002, data representative of ambient light received at a viewer is collected. For instance, referring to FIG. 11, light 1108 at viewer 108, shown in FIG. 9, is collected by a sensor system 1100. Sensor system 1100 may be positioned at a location of (e.g., near) viewer 108 of FIG. 9 or elsewhere in viewing environment 900. Sensor system 1100 may be coupled with display system 910 wirelessly or in a wired fashion to transmit and/or receive light data.

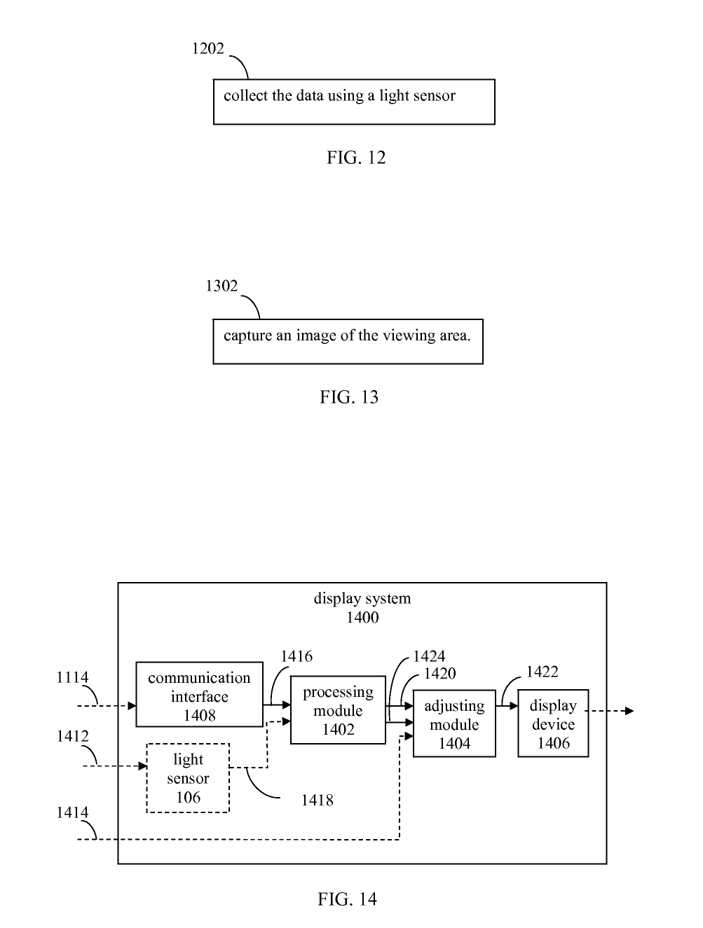

Data representative of ambient light received at a viewer may be collected according to one or more techniques. Light sensor 1102 and camera 1103 both enable sensor system 1100 to collect data representative of ambient light received at a viewer. For instance, FIG. 12 shows a step 1202 for collecting data representative of received light at a viewer location, according to an example embodiment. Step 1202 may be performed during step 1002 of flowchart 1000. In step 1202, data is collected using a light sensor. For example, in an embodiment, light sensor 1102 of FIG. 11 may be implemented as a light sensor similar to light sensor 106 shown in FIGS. 2 and 9. For instance, light sensor 1102 may include one or more of any type of light sensing device to collect data representative of ambient light, including a photosensor, a photodetector, a photodiode, etc. According to step 1202, light sensor 1102 is configured to output a sensed light indication 1110. Sensed light indication 1110 is a signal (e.g., a voltage, a digital value, etc.) that is indicative of the amount of light received by light sensor 1102 (e.g., indicative of brightness or light intensity) at one or more light wavelengths/frequencies.

Another example embodiment of collecting data representative of ambient light received at a viewer is described with respect to FIG. 13. FIG. 13 shows a step 1302 for collecting data representative of received light at a viewer location, according to an example embodiment. Step 1302 may be performed during step 1002 of flowchart 1000. In step 1302, an image of the viewing area is captured. For instance, in one embodiment, camera 1103 of FIG. 11 may be implemented as camera 212, as described above with respect to FIG. 6. According to step 1302, camera 1103 is configured to output a captured image 1109. For example, in an embodiment, camera 1103 is configured to capture an image of viewing environment 900 while focusing on viewer 108 as described above with reference to FIG. 6. In other embodiments, camera 1103 may capture an image of viewing environment 900 while focusing on an object (e.g., a wall or a ceiling), or when not focusing on a viewer or object.

Referring back to flowchart 1000 of FIG. 10, in step 1004, a light intensity of a viewing area is determined For example, in an embodiment, light intensity determining logic 1104, shown in FIG. 11, is configured to receive either sensed light indication 1110 or captured image 1109 from light sensor 1102 and camera 1103, respectively. In an embodiment, light intensity determining logic 1104 is further configured to process sensed light indication 1110 or captured image 1109 in order to determine a light intensity 1112 based on light 1108 at viewer 108 of FIG. 9. Light intensity determining logic 1104 may determine light intensity 1112 based on sensed light indication 1110 or captured image 1109 according to any suitable technique (including any technique mentioned elsewhere herein), as would be known to persons skilled in the relevant art(s). For instance, light intensity 1112 may be obtained by dividing a received light power or a luminous flux by a solid angle a planar area, or a combination of the two. Light intensity 1112 may also be determined from a captured image by implementing a computer algorithm or using a lookup table.

In step 1006 of FIG. 10, the light intensity is transmitted to the display system that is separate from the sensor system to enable the display system to adjust one or more display characteristics based on the transmitted light intensity. For example, as shown in FIG. 11, light intensity 1112 may be received by communication interface 1106. Communication interface 1106 enables sensor system 1100 to communicate with display system 910. Communication interface 1106 may transmit light intensity 1112 as a light intensity signal 1114 from sensor system 1100. Communication interface 1106 may be any suitable type of communication interface, wired or wireless, such as an as IEEE 802.11 wireless LAN (WLAN) wireless interface, a Worldwide Interoperability for Microwave Access (Wi-MAX) interface, a Bluetooth® interface, an Ethernet interface, a Universal Serial Bus (USB) interface, an infrared serial connection, etc.

Light sensor 1102, camera 1103, light intensity determining logic 1104, and communication interface 1106 may be implemented in hardware, software, firmware, or any combination thereof. For instance, light intensity determining logic 1104 may be implemented as a computer program code configured to be executed in one or more processors, including a generic processor and/or an image processor. Alternatively, light intensity determining logic may be implemented as hardware logic/electrical circuitry.

Embodiments for collecting data to determine light intensity with a sensor that is remote from the display device may be implemented in a variety of environments. For instance, flowchart 1000 may be implemented in a display system similar to display system 910 of FIG. 9. For instance, FIG. 14 shows a block diagram of a display system 1400, according to an example embodiment. Display system 1400 is an example of display system 910 shown in FIG. 9. Display system 1400 is similar to display system 210 shown in FIG. 4, with differences described as follows. As shown in FIG. 14, display system 1400 includes a processing module 1402, an adjusting module 1404, and a display device 1406, which are similar to processing module 402, adjusting module 404, and display device 406 of FIG. 4, respectively. Furthermore, display system 1400 optionally includes light sensor 106. Unlike display system 210 of FIG. 4, display system 1400 may not include camera 212, but may instead include a communication interface 1408. The elements of system 1400 are described as follows.

As shown in FIG. 14, communication interface 1408 enables display system 1400 to communicate with sensor system 1100. Communication interface 1408 may be a wired or wireless interface, such a communication interface described above for communication interface 1106. In an embodiment, communication interface 1408 is compatible with communication interface 1106. Referring back to step 1006 of FIG. 10, communication interface 1408 shown in FIG. 14 is configured to receive light intensity signal 1114 transmitted by sensor system 1100 via communication interface 1106.

As shown in FIG. 14, received light intensity 1416 is extracted from light intensity signal 1114, and output by communication interface 1408. Received light intensity 1416 is received and processed by processing module 1402. For instance, processing module 1402 may determine one or more light characteristics at the location of viewer 108, shown in FIG. 9, by processing received light intensity 1416. In one embodiment, a white balance level may be determined by processing module 1402 based on received light intensity 1416, in a manner as described in further detail above.

When light sensor 106 is present in display system 1400, light sensor 106 may receive light 1412, and may output sensed light indication 1418. Sensed light indication 1418 is a signal (e.g., a voltage, a digital value, etc.) that is indicative of an amount of light 1412 received by light sensor 106 (e.g., is indicative of brightness or light intensity) at one or more light wavelengths/frequencies. Processing module 1402 may receive sensed light indication 1418. Processing module 1402 may optionally use sensed light indication 1418 in combination with received light intensity 1416 to generate an effective measured light intensity value. The effective measured light intensity value may be a weighted average of received light intensity 1416 and sensed light indication 1418, or a value based on received light intensity 1416 and sensed light indication 1418 according to another linear or non-linear mathematical scheme (e.g., logarithm). The effective measured light intensity value. The effective measured light intensity value may be used to determine an appropriate color balance (e.g., a white balance level), in a manner as described in further detail above.

Processing module 1402 may be configured to determine an appropriate white balance level based on light characteristics derived from received light intensity 1416 and/or sensed light indication 1418. In an embodiment, if light characteristics indicate that the location of viewer 108 is dimly lit (e.g., low red, green, and/or blue pixel image values), the appropriate white balance level is generated to reflect the dim lighting condition. For example, under dim lighting condition, the white balance level may include a numerical number that is in a relatively lower range while under bright lighting condition the white balance level may include a numerical number that is in a relatively higher range. Additionally or alternatively, processing module 1402 may be configured to determine the white balance level based on received light intensity 1416 or sensed light indication 1418 by using other techniques known to persons skilled in the relevant art(s), such as by using a lookup table, for example.

As shown in FIG. 14, processing module 1402 may output an adjustment parameter 1420 indicating the determined white balance level and an adjustment parameter 1424 indicating the effective measured light intensity value. Adjustment parameters 1420 and 1424 may be generated periodically to accommodate changes in light levels in the environment. For instance, if display system 910 includes a portable display (e.g., cellular phone, etc.), adjustment parameters 1420 and 1424 may be generated more frequently to accommodate the portable display that may frequently be in motion leading to frequent changes in lighting condition of viewing environment 900. If display system 910 does not include a portable display, adjustment parameters 1420 and 1424 may be generated less frequently.

Adjustment parameter 1420 is similar to adjustment parameter 420 described above, and contains information that may be used to adjust one or more display characteristics based on the determined white balance level. For instance, display characteristics, such as brightness, may be adjusted by adding or subtracting an offset into red, green, and blue signals of a video signal such that black picture content appears as true black on the display screen of display device 1406 shown in FIG. 14. Furthermore, adjustment parameter 1420 may include a scale factor. Display characteristics, such as contrast, may be adjusted by applying the scale factor to the red, green, and blue signals of a video signal such that white picture content is rendered with an appropriate amount of detail on the display screen.

For instance, in an embodiment, if the determined white balance level indicates that viewing environment 900 is brightly lit from the perspective of viewer 108, adjustment parameter 1420 is generated to contain a relatively high or positive offset value. As a result, the brightness setting of display device 1406 may be adjusted by an increment of red, green, and/or blue pixel values. In another embodiment, if the determined white balance indicates that viewing environment 900 is dimly lit from the perspective of viewer 108, adjustment parameter 1420 is generated to contain a relatively low or negative offset value. As a result, the brightness setting of display device 1406 may be adjusted by a decrement of red, green, and/or blue pixel values.

Similarly, in one embodiment, if the determined white balance level indicates that the viewing environment 900 is brightly lit from the perspective of viewer 108, adjustment parameter 1420 is generated to include a relatively lower scale factor. As a result, the contrast setting of display device 1406 may be adjusted to a lower level. In another embodiment, if the determined white balance indicates that viewing environment 900 is dimly lit from the perspective of viewer 108, adjustment parameter 1420 is generated to contain a relatively larger scale factor. As a result, the contrast setting of display device 1406 may be adjusted to a higher level.

In another embodiment, a backlight level may be adjusted. If the effective measured light intensity value indicates viewing environment 900 is dimly lit, adjustment parameter 1424 is generated to have a value that causes the backlight level to be decreased to save power and to create an optimum viewing experience. However, if the effective measured light intensity value indicates that viewing environment 900 is brightly lit, adjustment parameter 1424 is generated to have a value that causes the backlight level to be increased such that the content on display screen 906 is adequately visible to viewer 108.

As described above with reference to step 1006 (FIG. 10), the light intensity is transmitted to the display system that is separate from the sensor system to enable the display system to adjust one or more display characteristics based on the transmitted light intensity. For example, in one embodiment, adjusting module 1404 of FIG. 14 is configured to receive adjustment parameter 1420 from processing module as well as video signal 1414. Video signal 1414 contains video content to be displayed by display screen 906 of display system 910. For instance, video signal 1414 may be received by display system 910 in a wireless or wired manner. For instance, video signal 1414 may be a land-based video broadcast transmission or a satellite broadcast transmission that may be received from a video source device such as a digital video disc (DVD) player, from a set top box (e.g., from cable), from a stereo receiver, from a hard drive, from a memory device, etc. Video signal 1414 may include video data transported in any form, including composite video, an S-video, component video signal, an HDMI (High-Definition Multimedia Interface) signal, etc.

Adjusting module 1404 may use adjustment parameter 1420 to modify video signal 1414 to modify display characteristics of display system 1400. Examples of display characteristics include backlight, contrast, brightness, color balance, etc. For instance, in an embodiment, to modify video signal 1414, adjusting module 1404 may add or subtract an offset or apply a gain to video signal 1414 based on adjustment parameter 1420 to generate a modified video signal 1422. Pixel data in video signal 1422 may be modified to bright colors, darken colors, apply contrast to colors, etc. As shown in FIG. 14, adjusting module 1404 generates modified video signal 1422, which is the adjusted form of video signal 414. Modified video signal 1422 is received by display device 1406, and is rendered for display by display screen 906.

In another embodiment, adjusting module 1404 is further configured to adjust the backlight level of display system 910 based on adjustment parameter 1424 received from processing module 1402. Adjusting module 1404 may adjust display system 910 more frequently when display system 910 includes a portable display, and adjustment parameter 1424 therefore changes value more frequently. In an embodiment, the backlight level may be adjusted by applying pulse-width modulation to a supply current, which causes the internal light sources 902 and 904 to turn on and off. The frequency of the pulse-width modulation determines how fast the internal light sources 902 and 904 switch on and off A low frequency (e.g., dim or low backlight level) may result in flicker that can cause discomfort and eye-strain, and a high frequency (e.g., full backlight level) may have a negative impact on image quality and excessive power consumption. Adjustment parameter 1424 may correspond to an appropriate frequency given the effective measured light intensity value. Alternatively, adjustment parameter 1424 may correspond to a change in frequency that is needed to provide the optimum viewing experience given the effective measured light intensity value. Adjusting module 1404 is configured to automatically adjust the backlight level of display system 910 based on adjustment parameter 1424 such that the content shown on display screen 906 is adequately visible to viewer 108. For example, in the case where display system 910 includes an LCD, the display screen 906 may appear dimmer or brighter, depending on the frequency of the pulse-width modulation used by adjusting module 1402. In the case where display system 910 is a display system in a vehicle, adjusting module 1402 may automatically adjust dashboard lights such that they appear dimmer or brighter according to adjustment parameter 1424.

The elements of display system 1400 may be implemented in hardware, software, firmware, or any combination thereof. For instance, processing module 1402 may be implemented as a computer program code configured to be executed in one or more processors, including a generic processor and/or an image processor. Alternatively, processing module 1402 may be implemented as hardware logic/electrical circuitry.

### IV. Example Device Implementation

Note that devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for light sensor 106, display system 210, camera 212, processing module 402, adjusting module 404, viewer detection module 602, autofocus module 604, image capture module 606, display system 910, sensor system 1100, light sensor 1102, camera 1103, light intensity determining logic 1104, communication interface 1106, display system 1400, communication interface 1408, processing module 1402, adjusting module 1404, flowchart 300, steps 302 304, 502, 504, 702, and/or 802, flowchart 1000, steps 1002, 1004, 1006, 1202, and/or step 1302 (including any one or more steps of flowcharts 300 and 1000), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

### V. Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a display system for adjusting a display system, comprising:
determining a white balance level using a light intensity determined from an image captured of a viewing area; and
adjusting one or more display characteristics of the display system based on the determined white balance level.

2. The method of claim 1, further comprising:
capturing the image of the viewing environment using at least one camera of the display system.

3. The method of claim 2, wherein said capturing comprises:
focusing the camera on a viewer in the viewing area; and
capturing the image with the camera focused on the viewer.

4. The method of claim 1, further comprising:
determining the light intensity under ambient lighting.

5. The method of claim 1, wherein the one or more display characteristics comprise a contrast level of the display system.

6. The method of claim 1, wherein the one or more display characteristics comprise a brightness level of the display system.

7. A system for adjusting display characteristics of a display system, comprising:
a camera configured to capture an image of a viewing area;
a processing module configured to determine a white balance level using a light intensity from the captured image, and
wherein at least one characteristic of the display system is adjusted based on the white balance level.

8. The system of claim 7, wherein the camera is further configured to transmit the captured image to the processing module; and
wherein the processing module is further configured to determine a light intensity from the captured image.

9. The system of claim 7, further comprising:
an adjusting module configured to
receive a video signal and an adjustment parameter from the processing module; and
generate a modified video signal based on the adjustment parameter.

10. The system of claim 7, wherein the light intensity is determined under ambient lighting.

11. The system of claim 7, wherein the imaging module is further configured to detect a viewer;
automatically focus on the viewer; and
capture the image with the imaging module focused on the viewer.

12. The system of claim 7, wherein the at least one characteristic comprises a contrast level.

13. The system of claim 7, wherein the at least one characteristic comprises a brightness level.

14. The system of claim 7, wherein the imaging module is in the display system.

15. The system of claim 7, wherein the imaging module is separate from the display system.

16. The system of claim 7, wherein the display system is portable.

17. The system of claim 7, further comprising:
a light sensor configured to detect the light intensity under ambient lighting.

18. A method in a sensor system, comprising:
collecting data representative of ambient light received at a viewer;
determining a light intensity of a viewing area; and
transmitting the light intensity to the display system that is separate from the sensor system to enable the display system to adjust one or more display characteristics based on the transmitted light intensity.

19. A method of claim 18, wherein said collecting data comprises:
collecting the data using a light sensor.

20. A method of claim 19, wherein said collecting data comprises:
capturing an image of the viewing area.
